(19) United States
(12) Patent Application Publication
(10) Pub. No.: US 2016/0185546 A1
(43) Pub. Date: Jun. 30, 2016

(54) Sticky Note Tape

(71) Applicant: Daniel Ernest Seger, Laurel, MD (US)

(72) Inventor: Daniel Ernest Seger, Laurel, MD (US)

(21) Appl. No.: 14/583,574

(22) Filed: Dec. 26, 2014

(51) Int. Cl. B65H 18/28; B42D 5/00; B65H 16/00

(52) U.S. Cl. CPC B65H 18/28; B65H 16/00; B42D 5/003

(57) ABSTRACT

An innovative method of dispensing a sticky note that allows a consumer to use the exact size he or she desires in any given use case.

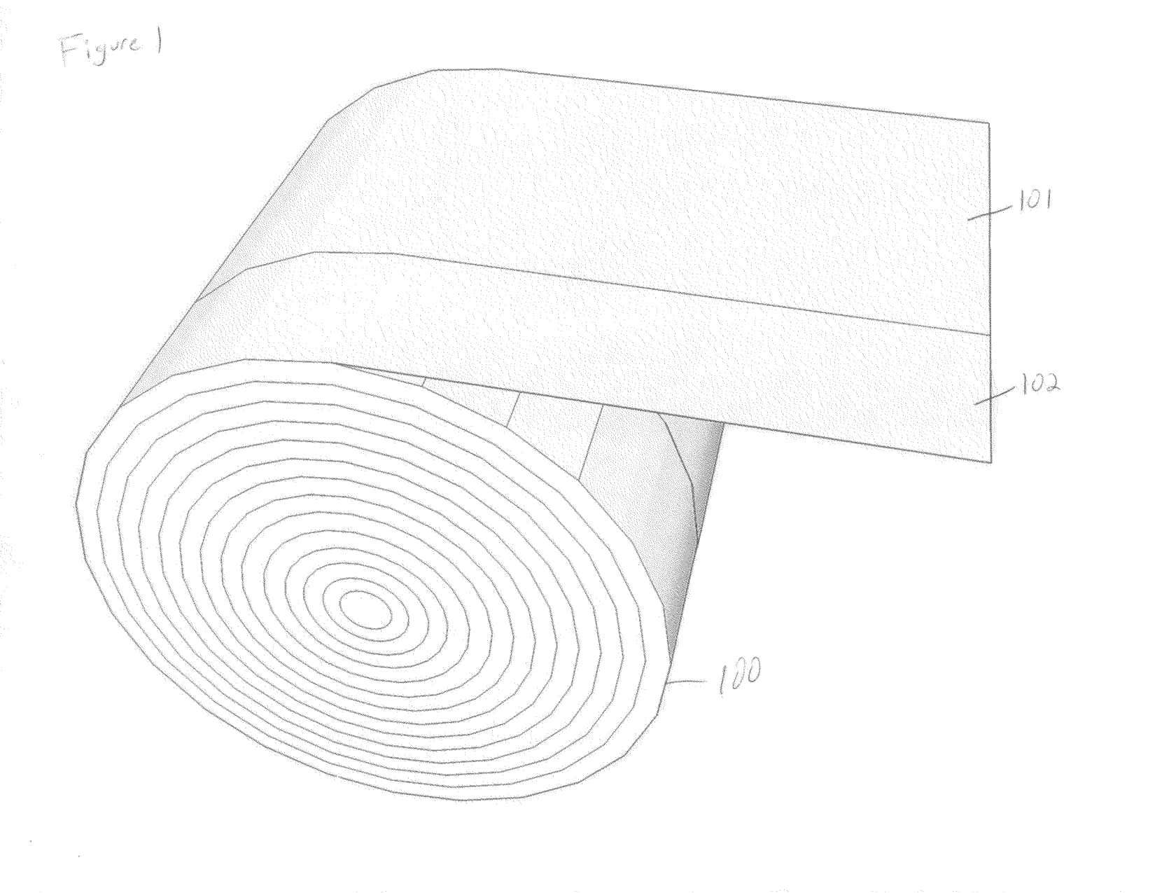

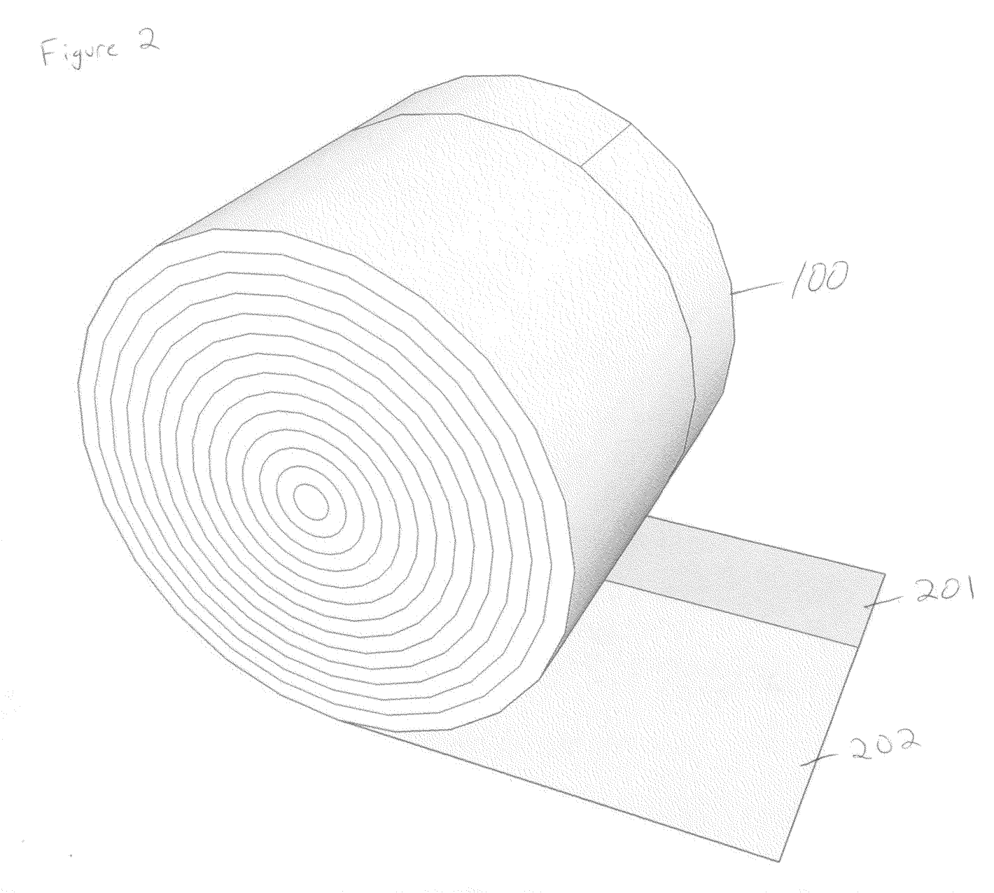

### BACKGROUND OF INVENTION

Sticky notes are not new to the world. One can easily find a variety of sticky note for multiple purposes. They are so functional that often a user would find him or herself using an entire sticky note when perhaps a quarter of one is all that is needed. The only present alternative known to this writer is to have multiple kinds of dispensers on one's desk in case a different use scenario comes along. To this writer's knowledge, no innovation exists to solve this problem. The present innovation aims to do just that. The method detailed herein does. It is simply one single, very long, sticky note that is rolled upon itself and dispensed in a similar manner as ordinary tape. This gives the user the ability to select a size of sticky note that he or she desires rather than being forced to use a single size for all purposes. In addition, this innovation allows for multiple dispensing strategies.

### DESCRIPTION OF INVENTION AND DRAWINGS

While within the prior art there exist many forms of sticky notes, each of those describes individual and separate sticky notes that are dispensed one-at-a-time. While these methods are convenient, they do not allow the user to alter the size of sticky note he or she would use. That one size is not always the most appropriate for a given situation. At present, another kind of sticky note of a different size must be available to use in a use case requiring a different size.

The present invention employs a method that allows the user to select any size sticky note he or she requires for a given task, without the need for another new pad of sticky notes. This is accomplished in the same manner as a roll of tape is dispensed.

Different dispensers could be designed to accommodate and dispense this variety of sticky note with varying degrees of ease and utility.

### DESCRIPTION OF DRAWINGS

100—Rolled-up sticky note tape.
101—The top, non-sticky, side of the paper.
102—The top, non-sticky, side of the paper, opposite of the adhesive.
201—The adhesive strip along one edge of the entire bottom side of the note.
202—The underside of sticky note, non-adhesive part.

### PATENT CITATIONS

| | | Publication | | |
|---|---|---|---|---|
| Cited Patent | Filing Date | Date | Applicant | Title |
| US20120114891 A1 | Nov. 4, 2010 | May 10, | L. David Smith | Sticky note and post it |
| | | 2012 | | note in a rolled form |
| U.S. Pat. No. 6,210,768 B1 | May 27, 1999 | Apr. 3, 2001 | Lana M. Blok, | Adhesive note |
| | | | Larry E. Wenzler, | dispensing roll having |
| | | | Gene A. Wright | individual release sheets |
| U.S. Pat. No. 4,989,801 A | Apr. 11, 1988 | Feb. 5, 1991 | Paul R. Thomas, | Adhesive note roll and |
| | | | William J. Scott | dispenser |

1. A method of dispensing sticky notes of any length the user desires.

2. The method of claim one consisting of a single sticky note rolled upon itself such that it is dispensed by unrolling it, exposing the adhesive element, in a similar manner as tape, capable of dispensing at any length the user desires.

3. The method of the above claims of any length, width, color or combination of colors, material, or of any pattern or shape of paper.

4. The method of the above claims with any amount, type, pattern, shape, or color of adhesive.

5. The method of the above claims with any number of adhesive strips of any strength of stickiness.
